(19) United States
(12) Patent Application Publication
(10) Pub. No.: US 2006/0002493 A1
(43) Pub. Date: Jan. 5, 2006

(54) Method and device for generating a duty cycle related output signal

(75) Inventor: Aaron Nygren, Munchen (DE)

Correspondence Address: Dicke, Billig & Czaja, PLLC;Fifth Street Towers, Suite 2250, 100 South Fifth Street, Minneapolis, MN, 55402, US

(73) Assignee: Infineon Technologies AG

(21) Appl. No.: 10/880,802

(22) Filed: Jun. 30, 2004

(51) Int. Cl. H04L 27/06

(52) U.S. Cl. 375/340

(57) ABSTRACT

The invention relates to a method and device for discriminating between defined logic states of a data signal received at at least one receiving unit on the basis of a reference voltage. An output signal relating to a duty cycle of an output signal of the receiving unit dependent on the voltage value of the applied reference voltage is output to a controller unit.

### BACKGROUND

The present invention relates to data signal transmission systems for discriminating the logic states of a data signal received in at least one receiver unit using a reference voltage, such as convenient DRAM memory systems. It especially relates to a method and device, which enable the identification of specified reference voltage values, which are adapted to a specific data signal and receiver unit in terms of duty cycle of the receiver unit output signal.

In a typical signal transmission system, be it a directional or unidirectional system, a driver transmits a signal from a first point via a line or transmission link to a second point, where the signal is received. Equally, in a bidirectional system, a signal can be sent from the second point to the first point of the transmission link of the transmission line, where it is likewise received and subsequently decoded. In the simplest case, a receiver unit forms the decoding of the data signal in the form of a conversion depending on the logic states thereof into a level that is known in each case. To that end, the output of the receiver unit is switched back and forth between the two known signal levels, depending on whether or not the received signal level exceeds a specific threshold value, which for example is given in the form of a reference voltage V_{ref}.

In prior art systems, the reference voltage V_{ref} is typically generated outside a signal transmission system and applied to the receiver units in the form of a predetermined voltage value. The value of the reference voltage is optimally (for example in the middle) placed between the ideal highest value and lowest value of the received data signal, independently of the leading and trailing edges of the signal, in order to achieve a duty cycle, that is, high time period/bit time period, of about 50%. However, in case the received data signal deviates from this optimal value, that is, from the optimal value of the reference voltage V_{ref}, non-optimal temporal tolerances, particularly in DRAM memory systems may occur, in which the data signals are expected to be completely symmetrical with regard to their leading and trailing edges, since set up time and hold time tolerances in that case are best.

However, there are a series of influencing variables that cause the reference voltage V_{ref} to deviate from this optimal value. Not only that the data signals itself may cause deviations, but also manufacturing of signal transmission systems, such as DRAM memory systems, is subject to fluctuations, so that suitably adapted V_{ref} should be determined separately for each specific signal transmission system.

German Patent DE 102 16 615 C1, assigned to the same applicant as the present invention, describes a method and device for generating an internal reference voltage instead of an external reference voltage for discriminating between the logic states of a data signal received at a receiving end. In such arrangement, an integrator for integrating an external clock signal is provided for generating the internal reference voltage from an integrated value of the clock signal. While such system indeed promises good results in terms of producing a 50% duty cycle from the receiver, it has yet to be proven that users wishing to rely on their own reference voltage standards prefer to apply reference voltages different from the internally generated reference voltage.

### SUMMARY

One embodiment of the present invention provides a method and device for discriminating between logic states of a received data signal, wherein suitably adapted reference voltage values may be identified, which lead to optimal signal time tolerances (that is, set up time tolerance and hold time tolerance).

In accordance with one embodiment of the invention, a method is provided for discriminating between defined logic states of a data signal received at at least one receiving unit on the basis of a reference voltage (V_{ref}). An output signal relating to a duty cycle of the receiving unit output signal dependent on the voltage value of the applied reference voltage is output to a controller unit. According to one embodiment of the invention, V_{ref} can be generated internally, controlled by an external controller or sent directly from extern.

Each user may be provided with information about the receiving unit signal output's duty cycle achieved, when a specific reference voltage value is applied. Varying the applied reference voltage, the user is enabled to choose that specific voltage value that is best suited to his or her needs in terms of identifying a specific reference voltage value that comes close to a specific duty cycle threshold value. In many cases this will be identical to 50%.

According to one embodiment of the invention, the output signal of the receiver unit indicates whether or not the duty cycle is above or below a specific duty cycle threshold value. Such output signal may easily be obtained by using a convenient resistor capacitor circuitry. Alternatively, according to another embodiment having more complex circuitry, the output signal of the receiver unit may indicate whether the duty cycle is within a specific range of duty cycle values, say ±5% or 1-2%, around a specific duty cycle threshold value. And, according to another embodiment, typically being most complex in circuitry, the output signal may also indicate a determined value of the duty cycle, which is considered exact within certain specific error margins.

According to another aspect, the invention also provides for a device for discriminating between defined logic states of a data signal received at at least one receiving unit on the basis of an externally applied reference voltage (V_{ref}). The device comprises at least one receiver unit having an input for receiving the data signal and an input for receiving the reference voltage in order to discriminate between the logic states of the data signal. According to one embodiment of the invention, the device also comprises at least one duty cycle detection unit for determining a duty cycle of an output signal of the receiver unit, which duty cycle is dependent on the reference voltage. The duty cycle detection unit has an output for outputting an output signal relating to said duty cycle to a controller unit, wherein said controller unit is for evaluating the output signal, especially in terms of the duty cycle being above or below a specific duty cycle threshold value, or alternatively, the duty cycle being within a specific range of duty cycle values, or, yet alternatively, the duty cycle having a specific value. The device may additionally comprise a display unit for displaying a result of the evaluation of the output signal in the controller unit.

In another embodiment of the invention, the duty cycle detection unit is specifically designed to provide low-frequency information and may be embodied by variety of filters known to those skilled in the art. For example, it may be embodied by a passive RC network, an active charge pump or the like.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a schematic diagram showing a typical embodiment of a device for discriminating between defined logic states of a data signal according to the invention.

FIG. 2a illustrates a schematic diagram that illustrates an embodiment of the duty cyle detection unit of FIG. 1.

FIG. 2b illustrates an exemplary graph of V_{lpf} versus duty cycle from FIG. 2a.

FIG. 3a illustrates a schematic diagram that illustrates another embodiment of the duty cyle detection unit of FIG. 1.

FIG. 3b illustrates an exemplary plot of output signal Vₒᵤₜ₂ versus V_{cmp} and duty cycle.

FIG. 4 illustrates a schematic diagram that illustrates another embodiment of the duty cyle detection unit of FIG. 1.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

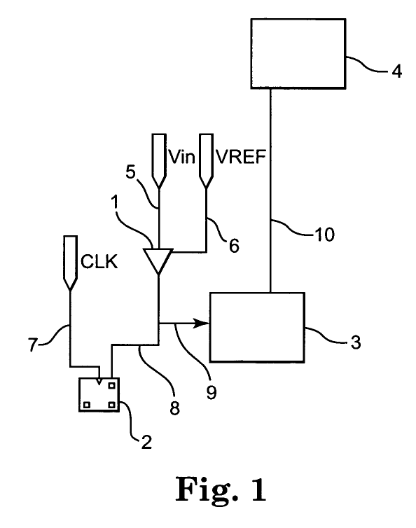

Referring now to the figures of the drawing in detail and first, particularly, to FIG. 1 thereof, a schematic diagram is illustrated of a typical embodiment of a device for discriminating between logic states of a data signal according to the invention. For example, such schematic could be part of a DRAM memory system, but is not restricted to such an application. The device of FIG. 1 is comprised of a receiving unit 1 provided with inputs for receiving a data signal Vᵢₙ via line 5 and external reference voltage V_{ref} via line 6, respectively. Based on the input data signal Vᵢₙ and reference voltage V_{ref}, an output signal V_{rcv} is generated in the receiving unit 1. The output signal V_{rcv} toggles between both a specific high and low output voltage value based on the crossing points of the data signal and reference voltage, as well as the characteristics of the receiver unit 1 itself. The output signal V_{rcv} is supplied to a latch unit 2 via line 8 for data buffering. The latch unit 2 is provided with an external clock signal CLK via line 7. In order to gain maximum temporal tolerances, that is, set up time and hold time tolerances, the clock signal CLK is suitably adapted to a 50% duty cycle data output signal.

According to one embodiment of the invention, a duty cycle detector 3 for determination of a duty cycle of the output data signal V_{rcv} of receiving unit 1 is provided, which receives the output data signal via line 9. Further, an output signal of said duty cycle detector 3 is output via line 10 to a controller unit 4 for evaluating the output signal from said duty cycle detector.

In using the above-described device according to one embodiment of the invention, a method for discriminating between defined logic states of a data signal Vᵢₙ received at the receiving unit 1 on the basis of the externally applied reference voltage V_{ref} may be done, wherein a duty cycle related output signal dependent on the voltage value of the applied reference voltage is output to the controller unit 4 for its evaluation. Upon doing so, each user is enabled to vary reference voltage V_{ref} applied to the receiving unit 1 in order to suitably adapt and especially optimize, duty cycle of the output signal of receiving unit 1 to be supplied to latch unit 2 dependent on varied reference voltage V_{ref}.

While in FIG. 1 reference voltage V_{ref} and data signal Sᵢₙ applied to the receiving unit 1 have been shown to be supplied from outside of the device, for instance by a user itself, it may also be that data signal and reference voltage are fed by controller unit 4.

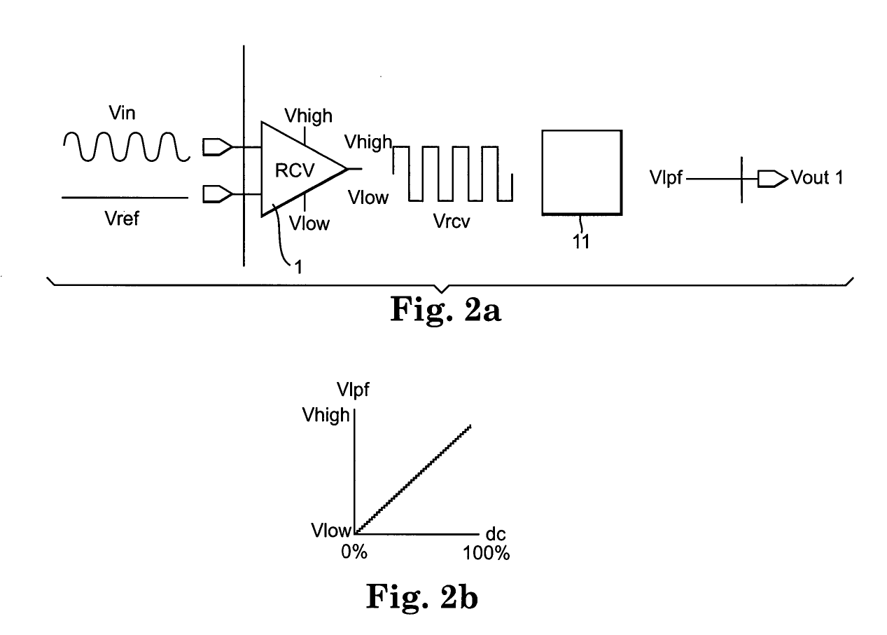

The schematic diagram of in FIG. 2a illustrates a detailed embodiment of the device of one embodiment of the invention comprising a receiving unit 1 and a duty cycle detection unit 3. A data signal Vᵢₙ and reference voltage V_{ref} are input in the receiver unit 1. An output signal V_{rcv} reflecting bit pattern of input data signal Vᵢₙ is output from the receiver unit 1, and dependent on whether the input data signal Vᵢₙ is above or below a threshold voltage value defined by said reference voltage, toggles between a high voltage value V_{high} and a low voltage value V_{low}. Output data signal V_{rcv} of the receiver unit 1 is then fed to a low pass filter 11, which is considered to be the fundamental block unit of said duty cycle detection unit. Voltage V_{lpf} generated by the low pass filter 11 is fed to the controller unit 4 as output signal Vₒᵤₜ₁.

The low pass filter 11 could be constructed from a resistor capacitor (RC) circuit in its simplest form, or may be a more complex circuit, depending on desired accuracy. The direct analog output signal V_{lpf} of the low pass filter can then be interpreted by the controller unit 4 to evaluate the internal duty cycle. In case said low pass filter 11 is constructed from a RC circuit, information as to whether or not said duty cycle is above or below a specific duty cycle threshold value, defined by said RC circuit, may be obtained. Otherwise, using more complex circuitry, a steady output signal V_{lpf} proportional to the duty cycle of V_{rcv} may be obtained. FIG. 2b illustrates an exemplary graph of voltage V_{lpf} versus duty cycle (dc).

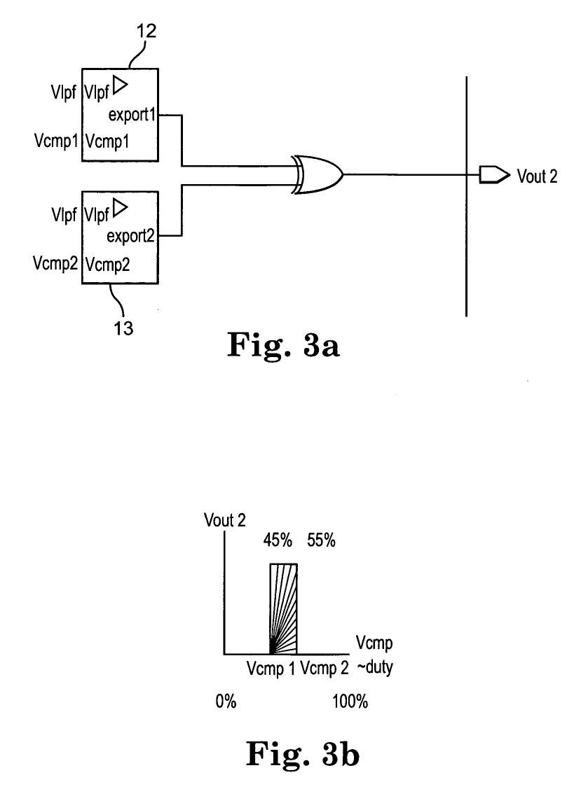

The schematic diagram of FIG. 3a illustrating another detailed embodiment of the device of the invention comprises further circuitry additionally to the low pass filter of FIG. 2a. Accordingly, the logical output signal of the low pass filter V_{lpf} is fed to two comparator units 12, 13, and is triggered by the two set voltage values V_{cmp1}, V_{cmp2} of both comparator units 12, 13. The values of V_{cmp1} and V_{cmp2} can be set to generate any trigger point. Generated voltage values are supplied to the controller unit 4 as output signal Vₒᵤₜ₂.

As can be taken from the graph illustrated in FIG. 3, in which output signal Vₒᵤₜ₂ is plotted versus V_{cmp} and duty cycle, respectively, information is given whether or not said duty cycle is within a specified range of duty cycle values, which in the graph of FIG. 3b is chosen to vary from 45% to 55%, that is, ±5% around duty cycle threshold value 50%.

Using the circuitry of FIG. 3a, one could also generate a step waveform output at a value of 50% duty cycle with an input, for example, of V_{cmp1}=(V_{high}−V_{low})/2 and V_{cmp2}=V_{high}, which results in the same as if only one comparator would exist (simpler implementation).

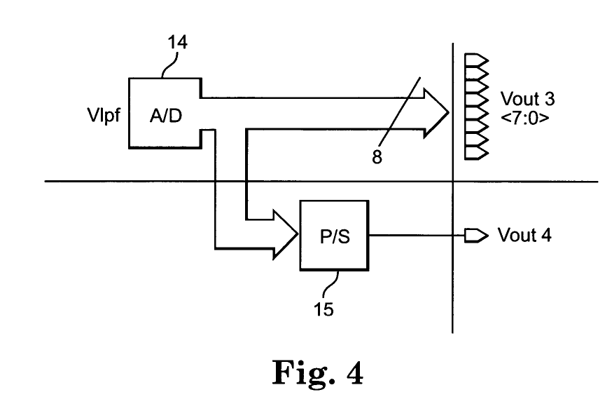

The schematic diagram of FIG. 4 illustrating another detained embodiment of the device of the invention comprises further circuitry addionally to the low pass filter of FIG. 2a, wherein a analog/digital (A/D) converter unit 14 is provided for converting analog low pass filter output signal V_{lpf} to a digital value Vₒᵤₜ₃ coded with as many bits as necessary for a desired accuracy. In the example shown in FIG. 4, 8 bits read out by 8 pins allow for a step resolution of (V_{high}−V_{low})/256. The binary word could be read out of existing pins such as data or address pins.

Also, in FIG. 4 a variant is illustrated, which works the same as in producing digital outpt value Vₒᵤₜ₃ except that the binary word is converted to a serial bit stream by the parallel-to-serial (P/S) converter unit 15. The bit stream can then be read out of one pin instead of multiple pins.

The method and device according to the invention for discriminating between logic states of a data signal received at at least one receiving unit on the basis of an externally applied reference voltage is essentially based on the fact that an output signal in relation to a duty cycle of an output data signal of said receiving unit, generated by at least one duty cycle detection unit for determining the output data signal's duty cycle dependent on said applied external reference voltage is output to a controller unit for its evaluation, such that a reference voltage value suitably adapted to a specific duty cycle threshold value may be identified.

The method and device according to the invention can be employed in any data transmission system or signal transmission system, in which a unidirectional or bidirectional data or signal transmission takes place and in which logic states of the received data signal are decoded by the discrimination by way of a reference voltage which has a level between the highest and the lowest level of the received data signal, such as DRAM memory systems.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for discriminating between defined logic states of a data signal received at at least one receiving unit on the basis of a reference voltage comprising outputting to a control unit a duty cycle related output signal that is dependent on the voltage value of the applied reference voltage.

2. The method of claim 1, wherein the output signal indicates whether the duty cycle is above or below a specific duty cycle threshold value.

3. The method of claim 1, wherein the output signal indicates whether the duty cycle is within a specific range of specific duty cycle values.

4. The method of claim 1, wherein the output signal indicates a determined value of the duty cycle.

5. The method of claim 1, wherein an output signal proportional to the duty cycle is output to the controller unit.

6. The method of claim 1, wherein before the output signal is sent to the control unit, the output signal is fed to two comparators.

7. The method of claim 1, wherein before the output signal is sent to the control unit, the output signal is converted from an analog signal to a digital signal.

8. The method of claim 7, wherein the digital signal is converted to a serial bit stream for further processing.

9. A device for discriminating between defined logic states of a data signal on the basis of a voltage, the device comprising:
at least one receiver unit having an input for receiving the data signal and an input for receiving the reference voltage for the discriminating of the logic states of the data signal; and
at least one duty cycle detection unit for determining a duty cycle of an output signal of the receiving unit dependent on the reference voltage and having an output for outputting an output signal relating to the duty cycle to a controller unit, the controller unit being for evaluating the output signal of the duty cycle detection unit.

10. The device of claim 9, wherein the duty cycle detection unit is adapted to provide low-frequency information.

11. The device of claim 10, wherein the duty cycle detection unit is a low pass filter unit.

12. The device of claim 9, further including two comparators configured between the at least one duty cycle detection unit and the controller unit.

13. The device of claim 9, further including an analog-to-digital converter between the at least one duty cycle detection unit and the controller unit.

14. The device of claim 13, further including a parallel-to-serial converter unit.

15. A device for discriminating between logic states of a data signal based on a reference signal, the device comprising:
a receiving unit configured to receive the data signal and the reference signal and configured to discriminate the logic states of the data signal and output a first output signal;
a duty cycle detection unit configured to receive the first output signal, to determine the duty cycle thereof, and to output a second output signal; and
a controller unit configured to receive and evaluate the second output signal.

16. The device of claim 15, wherein the duty cycle detection unit is a low-pass filter.

17. The device of claim 15, further including two comparators configured between the duty cycle detection unit and the controller unit.

18. The device of claim 15, further including an analog-to-digital converter configured between the duty cycle detection unit and the controller unit.

19. The device of claim 18 further including a parallel-to-serial converter unit.

20. The device of claim 15, wherein the duty cycle detection unit is adapted to provide low-frequency information.
